(19) United States
(12) Patent Application Publication
(10) Pub. No.: US 2018/0255850 A1
(43) Pub. Date: Sep. 13, 2018

(54) Neutralized Capacitors as a Portable Source of Antioxidants

(71) Applicant: Joshua Benjamin Sullum, Poughkeepsie, NY (US)

(72) Inventor: Joshua Benjamin Sullum, Poughkeepsie, NY (US)

(21) Appl. No.: 15/607,495

(22) Filed: May 28, 2017

Related U.S. Application Data
(60) Provisional application No. 62/601,096, filed on Mar. 9, 2017.

(51) Int. Cl. A41D 20/00; H05F 7/00

(52) U.S. Cl. CPC A41D 20/00; H05F 7/00

(57) ABSTRACT

Neutralized capacitors can be used as a source of antioxidants. A simple way to achieve this goal is to connected the neutralized capacitors to an ESD strap, and the capacitors can be placed in a pouch or tucked in a wristband. Variations of the application of neutralized capacitors as antioxidants are possible and included in this patent; headbands, calf bands, wristbands, and apparel or devices containing neutralized capacitors all fall under this patent.

### CROSS-REFERENCE TO RELATED APPLICATIONS

62/601,096

62/495,401

### BACKGROUND

The body is a machine that runs on electricity. The heart and veins need electrons. Antioxidants can relieve symptoms and diseases caused by oxidative stress, free radicals and inflammation. When free radicals attack the body, inflammation occurs. Inflammation can be regulated by antioxidants. Molecules that serve as antioxidants donate electrons.

People need electrons to maintain optimal health. Electrons are available in nature in the earth at 0 volts. Capacitors store electrons. Common voltages of capacitors are 2.7, 16, 25, or 50 volts. These voltages can potentially cause harm to people. For a capacitor to be capable of storing electrons at zero volts, the positive and negative ends must be connected and thereby neutralized to 0 volts. Now, the capacitor can be connected to an electrode and draw energy from the ground port of an outlet or from the earth directly. This energy drawn is in the form of zero volt electrons.

Recent research is available:

Health Implications of Reconnecting the Human Body to the Earth's Surface Electrons. https://www.ncbi.nlm.nih.gov/pmc/articles/PMC3265077/

The effects of grounding on inflammation, the immune response, wound healing, and prevention and treatment of chronic inflammatory and autoimmune diseases. https://www.ncbi.nlm.nih.gov/pmc/articles/PMC4378297/

Similarly, in electronics, when a battery undergoes chemical reactions, electrical energy is released. In this sense, a battery is similar to an antioxidant. One major difference is that batteries give off electrons at voltages higher than 0. The voltage of these electrons released varies by battery type. Battery voltage is commonly 1.5 or 9 V.

Capacitors are another common component in electronics. Capacitors of high electrical capacity may be called supercapacitors or ultracapacitors. For the purpose of this patent, all such electrical devices (super- and ultracapacitors) are included in the definition of “capacitor”.

When connected to a closed circuit, capacitors can build up a storage of electrons at a voltage corresponding to the power source (often a battery). These electrons can be stored in and later discharged from the capacitor. If, however, the circuit is disrupted and the positive and negative ends of the capacitor touch each other, then voltage neutralizes to 0V.

Note that the electrons at this point do not disappear, as per the first law of thermodynamics (Energy in the universe is conserved). Hence, the electrons stored at both ends of the capacitor are now at 0V. This value of 0V is significant in health sciences for the following reason: 0V equals the voltage of a healthy person, animal, plant, and ground. Since the voltage corresponds to human biology, the user will not incur voltage-related damage to his body. In fact, the electrons can be infused into a person directly for antioxidant effects.

### BRIEF SUMMARY

Electrons can be drawn from the ground via electrode into a neutralized capacitor and then be released into a person for health purposes.

### DESCRIPTION OF DRAWINGS

Wire connects capacitor ends to each other for neutralization. Electrodes draw electrons from ground into capacitor. Capacitors are connected to an ESD strap for discharge into a person.

FIG. 1 shows a neutralized capacitor.

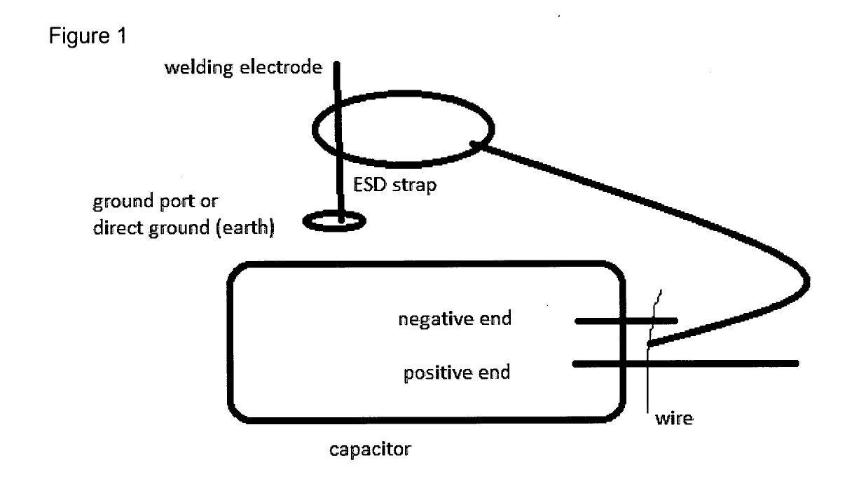

FIG. 2 shows multiple neutralized capacitors connected to each other and suitable for placement in a wearable wristband. The wristband can be recharged and then used as a portable source of antioxidants.

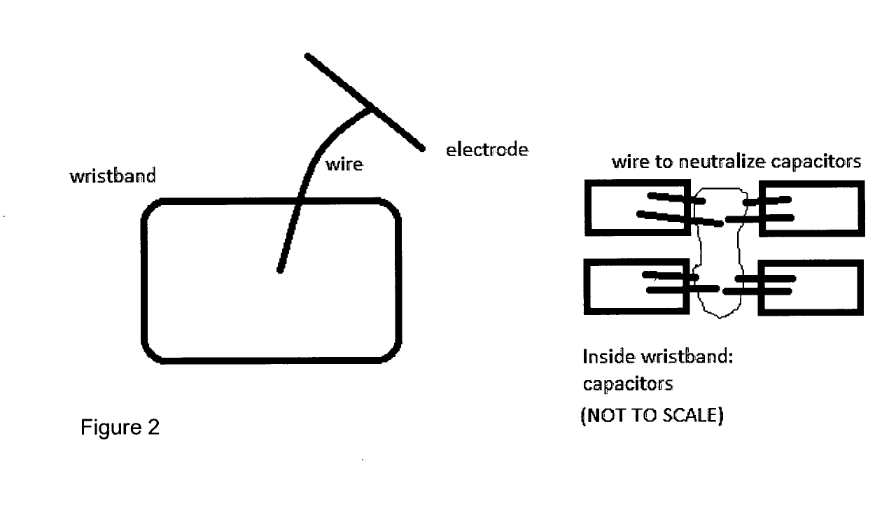

FIG. 3 shows supercapacitors neutralized and connected. A larger pouch is suitable to carry supercapacitors. The electrons from the supercapacitors are released via wire and ESD strap into the person.

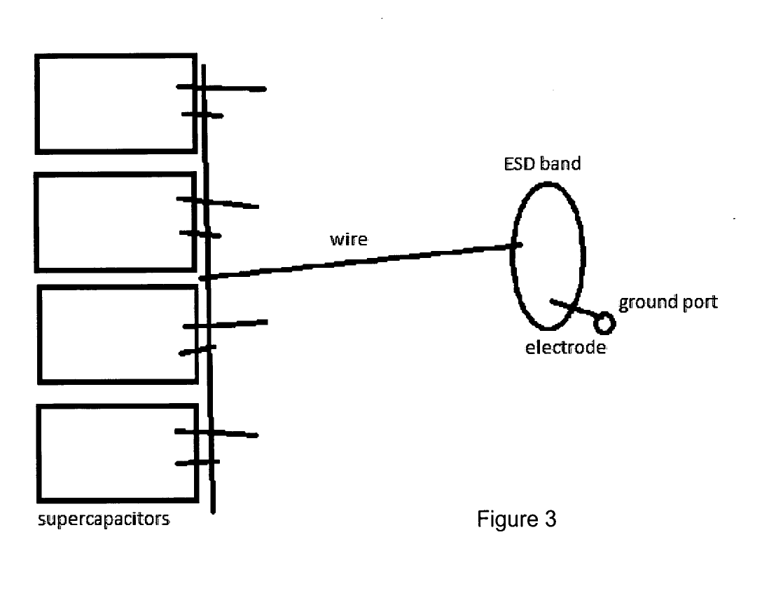

### DETAILED DESCRIPTION OF INVENTION

Electrons are a source of energy for humans. A large number of supercapacitors can be neutralized, connected and recharged and become a significant source of electrons for several hours for human use during the day or night. Alternatively a wristband with smaller capacitors can be worn and used but recharged more frequently.

Capacitors can either be neutralized and then charged from the ground or charged from a battery and then neutralized. If a person touches and maintains contact with the metal ends of a charged neutralized capacitor, then the person creates a circuit with the capacitor and can take energy from it.

Capacitors can thereby serve a source of antioxidants (electrons) without causing any voltage damage that could otherwise be associated with batteries, capacitors, and other electronic components. Further, capacitors can serve as preventative medicine to prevent onset of inflammatory diseases.

Neutralized capacitors containing electrons can serve as medical antioxidants. “Medical” for the purpose of this patent refers to, but is not limited to, applications in the health or disease of any person, animal, plant, or other living entity. “Antioxidant” for the purpose of this patent refers to, but is not limited to, the prevention or cure of biological processes that occur due to electron deficit and are harmful to the living organism.

The devices are a rechargeable portable source of physical antioxidants; they are physical antioxidants as opposed to biochemical. Physical implies that the electrons are free and pure, unattached.

People in modern society are deficient in electrons. This implies a deficiency in energy. Electrons are energy just like photons of light. By analogy, you benefit from sunshine. In the case of electrons, your body craves energy in the form of electricity. Not just electricity in the sense of a current, or force that pushes biochemicals and molecules in the body—but electricity in the sense of actual electrons. Antioxidant supplements that are swallowed are in the form of biochemicals that contain electrons. Such biochemicals are limited in their reach within the body, in contrast to physical free electrons released into the body through the skin. Commonly people seek relief in the form of pills. I believe that it is possible to receive therapy and relief through other means. In the case of chronic disease and inflammation, electron deficiency may be a major culprit. The effect of infusing the body with zero volt free electrons is an improvement in overall health as well as in acute or chronic problems.

Major factors in health include diet, exercise and sleep hygiene. Additional factors include social life, spiritual pursuits, economic standing, and education level. All of these factors are intertwined and play integral roles in sustaining the healthy lives of the citizens of our country today.

A person may may completely proactive toward health with respect to all of the above but still feel like something is missing and they are losing an uphill battle. Electrons at a healthy level of force can serve a versatile source of energy to improve lives. These electrons inside the neutralized capacitor are at 0 volts and unattached to any molecules. They can enter the body readily from the palm of the hand or from the foot. Long term effects of use may include better bodies and smarter minds.

Neutralized capacitors serve as biotechnology that delivers you a stream of free electrons at 0 volts. Placing an electrode on the ESD strap may facilitate improved transfer of electrons into skin.

Our products provide you with access to free electrons at biological level. The implications and reasons for using this product can be many. Athletes, students and professionals may have a competitive edge, and everyone may experience improved health. We here at Sparky believe everyone deserves better health every day.

Capacitors are electronic components that can store electrons. In electronics, capacitors typically store electrons at a voltage, or potential difference. If however the two ends of a capacitor are connected, then the capacitor is neutralized. The charge thus becomes 0 volts. The electrons do not disappear; they are still in the ends of the capacitor. From those ends, you can take them into your body through your skin. Living naked in nature, you would take in electrons unconsciously. In modern society, the electrical roots of our minds and bodies are disconnected from the electrical sources of nature. As a result, we suffer with chronic diseases and sub-optimal health. The goal of Sparky Elecrofuse is to provide you with sustainable solutions to better health every day.

Research and development, prototyping, and manufacturing bioelectronics that incorporate neutralized capacitors are protected by this patent.

How to charge:

Option 1: Place electrode in a ground port that is properly grounded. Most are.

Option 2: Stick electrode into soil.

How to wear the gear: Place the electrode at the location on the skin where you wish to charge. For example, hold the electrode at the center of the palm or tuck it into the band. Tuck the headpiece electrode over your ear to charge your mind.

Three minutes is ample charging time. Discharge varies per person, so the capacitor pack may need recharging every hour for best results.

The fundamental key to recharging a person or a capacitor is connection to the earth. The easiest, most accessible way to charge the patent-pending neutralized capacitor pack inside the armbands and headbands is to place the ends of the wire into the ground port of an outlet. If you view the outlet as a face, the mouth is what electrical engineers call the ground port.

Free electrons are electrons that can readily flow from atom to atom. They are not stuck in any one molecule or to any one atom. Free electrons are abundant in nature, especially in oceans, mud, living grass and exposed portions of tree roots.

You could recharge the capacitors is by placing the electrode on a metal freezer rack or on your radiator. Alternatively you could recharge them directly in the grass, ocean, sidewalk, or bare tree roots!

Capacitors are electronic components that can store electrons. In electronics, capacitors typically store electrons at a voltage, or potential difference. If however the two ends of a capacitor are connected, then the capacitor is neutralized. The charge thus becomes 0 volts. The electrons do not disappear; they are still in the ends of the capacitor. From those ends, you can take them into your body through your skin. Living naked in nature, you would take in electrons unconsciously. In modern society, the electrical roots of our minds and bodies are disconnected from the electrical sources of nature. As a result, we suffer with chronic diseases and sub-optimal health. The goal of Sparky Elecrofuse is to provide you with sustainable solutions to better health every day.

This invention involves the combination of electrostatic discharge (ESD) bands, also known as antistatic wristbands, and welding electrodes, wires and capacitors. Wire connects the positive end(s) to the negative end(s) of the capacitor. The wire extends to an ESD band. The capacitor, now neutralized, is connected to the band. The capacitor can thus be charged. Place a welding electrode in the ground port of an outlet. Hang the ESD band through the electrode. The electrons travel on the electrode, across the band and wire and ultimately into the neutralized capacitor. After this, take the ESD band off the electrode. Place the band on the arm. Now, zero volt free electrons will travel through the wire, into the band, and ultimately into the person. A person on the go thereby receives an infusion of electrons and can wear this gear normally throughout the day as a portable source of energy for better health. Recharging approximately every hour and having a stock of multiple capacitors on the charging dock (electrode) may facilitate optimal quantity of electrons.

The more electrons available, the better. If your body has enough, the electrons will stay in the capacitor. Unlike medications, it is not possible to cause problems and side effects with zero volt free electrons. Most of the time, your body will be craving the electrons to recharge the organs, tissues and cells anyway, and electron deficiency is the normal (i.e. what is prevalent) state of the human body.

So the average person may have a stock of a dozen supercapacitor devices and wear new ones every hour or so.

In conclusion, if capacitors are properly charged and then neutralized as per the above description, then they can serve as a source of electrons to cure and prevent diseases associated with inflammation. This patent protects the innovative utility of electronic capacitors as antioxidants. The utility of capacitors is hereby protected against theft to the extent possible by United States law.

1. Capacitors can be neutralized in order to store and discharge zero-volt electrons.

2. Neutralized capacitors can serve as a source of antioxidants for humans.
